(19) United States
(12) Patent Application Publication
(10) Pub. No.: US 2014/0355256 A1
(43) Pub. Date: Dec. 4, 2014

(54) ILLUMINATED COAT DEVICE

(71) Applicant: Shawn Mark Curtis, Poughkeepsie, NY (US)

(72) Inventor: Shawn Mark Curtis, Poughkeepsie, NY (US)

(21) Appl. No.: 13/903,730

(22) Filed: May 28, 2013

(51) Int. Cl. F21V 33/00

(52) U.S. Cl. CPC F21V 33/0008
USPC 362/108

(57) ABSTRACT

An illuminated coat device is worn so that while in the dark, the wearer may be visible and distinguishable. The device may include a coat with a trim, a plurality of lighting attached to the trim of the coat, a plurality of straps attached to a first side of the coat at a secure end, and wrapped around the wearer and removably attached to a second side of the coat. A power pack attached to the coat provides the power for the lighting to illuminate, as well as hold a switch that adjusts the intensity of the illumination of the plurality of lighting.

### BACKGROUND OF THE INVENTION

The present invention relates to animal coats and, more particularly, to illuminated animal coats.

Currently, when an animal or pet is out in the night time it can be hard to see and identify. If the animal runs off, it is hard to view the specific animal, especially if there are multiple animals in the same area. An owner needs a way to recognize their own pet among a group of animals at night, as well as being able to track their own pet in the dark on their own.

As can be seen, there is a need for an illuminated animal coat device that will allow for visibility.

### SUMMARY OF THE INVENTION

In one aspect of the present invention, an illuminated coat device comprises a coat comprising a trim; a plurality of lighting attached to the trim of the coat; a plurality of straps comprising a secure end and a removable end, wherein the secure end is attached to a first side of the coat and the removable end is removably attached to a second side of the coat; and a power pack comprising a power source and a switch, wherein the power pack connects to the plurality of lighting by wiring and is attached to the coat.

In another aspect of the present invention, a method for identifying a wearer in a location comprises placing the coat on a wearer's back; wrapping the plurality of straps around the body of the wearer; attaching the plurality of straps to the second side of the coat; confirming that the power source is operable; and adjusting the switch to the required illumination intensity.

These and other features, aspects and advantages of the present invention will become better understood with reference to the following drawings, description and claims.

### BRIEF DESCRIPTION OF THE DRAWINGS

FIG. 1 is a perspective view of an illuminated coat device, in use, according to an exemplary embodiment of the present invention;

FIG. 2 is a perspective view of the illuminated coat device of FIG. 1; and

FIG. 3 is a cross-sectional view taken along line 3-3 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an illuminated coat device that is worn so that while in the day time or in the dark, the wearer may be visible and distinguishable. The device may include a coat with a trim, a plurality of lighting attached to the trim of the coat, a plurality of straps attached to a first side of the coat at a secure end, and wrapped around the wearer and removably attached to a second side of the coat. A power pack attached to the coat provides the power for the lighting to illuminate, as well as hold a switch that adjusts the intensity of the illumination of the plurality of lighting.

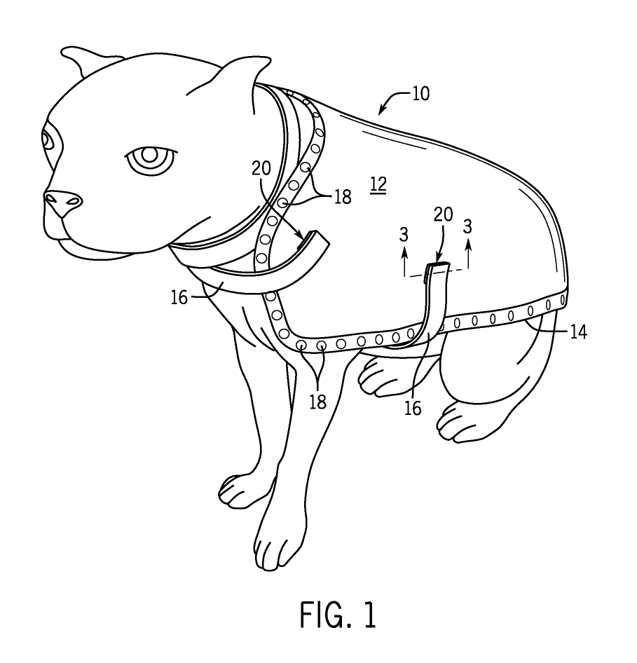

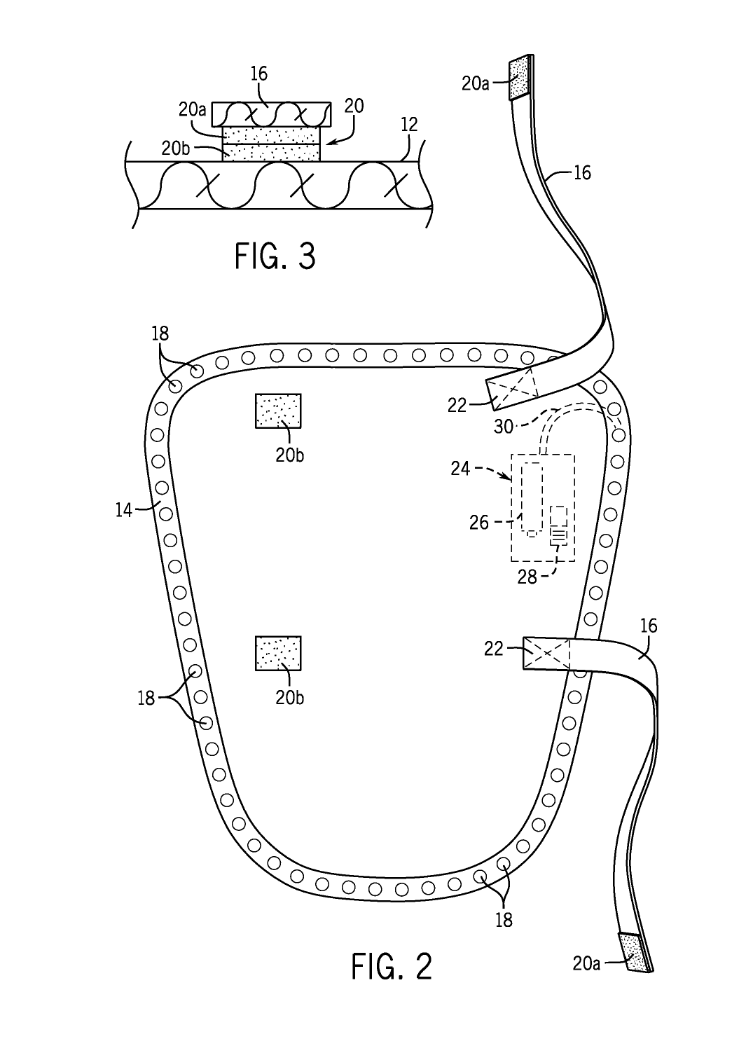

As is illustrated in FIGS. 1 through 3, an illuminated coat device 10 according to an exemplary embodiment of the present invention may include a coat 12. The coat 12 may be accented with a trim 14 along the edge of the fabric. Lighting 18 may be attached to the illuminated coat device 10 along its trim 14. Lighting 18 may be in the form of light emitting diodes (LEDs) or the like.

In order to keep the illuminated coat device 10 on an animal or pet, a plurality of straps 16 may be attached to one side of the coat 12 by stitching 22 a secure end of each strap 16 to the coat 12. The other end of the straps 16, a removable end, can include a hook fastener 20a, such as Velcro® style hook fastener, or the like. Placed on the opposite end of the coat 12 from the stitching 22, may be a loop fastener 20b, wherein the hook fastener 20a and loop fastener 20b, make up a hook and loop fastener system 20 securing the illuminated animal coat device 10 in place on the animal or pet. The hook and loop fastener system 20 may be made of Velcro® as is mentioned above, or any other connecting system that allows for a secure fit and easy release. The plurality of straps 16 may be placed over and around the belly of the animal as well as around and over the chest area of the animal to provide a snug fit that allows for the illuminated animal coat device 10 to stay on the animal through the animal's movements.

The lighting 18 may be connected to wiring 30 which may be connected to a power pack 24 that may be sewn into the fabric of the coat 12. The power pack 24 comprises a space for a battery 26 and a switch 28. The switch 28 can adjust the level of illumination coming from the lighting 18. A remote may also be used to adjust the level of illumination coming from the lighting 18 attached to the coat 12.

A method of making the illuminated coat device may comprise the following steps: determining the needs for the specific user, sewing the fabric together, securing the lighting along the edge of the fabric, wiring the lighting to a power pack which is sewn into the fabric, the power pack may contain a battery and switch. The level of illumination may be controlled by the switch on the power pack attached to the coat or by a remote.

In certain embodiments, the present invention has multi-colored lighting. The lighting may also be located on the device other than just on the trim. In certain embodiments, the present invention is in the form of a blanket. The fabric may be a solid color or multicolored. In certain embodiments, the present invention may be fit to cover larger animals other than pets. In an alternate embodiment, the present invention may be used for the safety of children by illuminating the coat of the child. The child will stand out in dark areas, thereby allowing the parent to be able to see the child at night. In an alternate embodiment, an adult may wear the device. The wearer of the device may be a cheerleader or the like with the lighting in a pattern detailing a logo.

It should be understood, of course, that the foregoing relates to exemplary embodiments of the invention and that modifications may be made without departing from the spirit and scope of the invention as set forth in the following claims.

What is claimed is:

1. An illuminated coat device comprising:
a coat; a trim disposed about a periphery of the coat;
a lighting attached to the trim of the coat;
at least one strap comprising a secure end and a removable end, wherein the secure end is attached to a first side of the coat and the removable end is removably attached to a second side of the coat; and
a power pack comprising a power source and a switch, wherein the power pack is attached to the coat and the power pack is connected to the lighting through wiring.

2. The illuminated coat device of claim 1, wherein the power source is a battery.

3. The illuminated coat device of claim 1, wherein the removable end of the plurality of straps is removably attached to the coat by hook and loop fastener.

4. The illuminated coat device of claim 1, further comprising a remote to adjust the switch remotely.

5. The illuminated coat device of claim 1, further comprising the lighting attached to the first side of the coat and to the second side of the coat.

6. A method for identifying a wearer in a location, the method comprising:
placing the coat on a wearer's back;
wrapping the at least one strap around the body of the wearer;
attaching the at least one strap to the second side of the coat;
confirming power source is operable; and
adjusting the switch to the required illumination intensity.

7. The method of claim 6, further comprising adjusting the required illumination intensity by a remote.

8. The method of claim 6, wherein the wearer is an animal.

9. The method of claim 6, wherein the wearer is a human.
